(19) United States
(12) Patent Application Publication
(10) Pub. No.: US 2023/0348710 A1
(43) Pub. Date: Nov. 2, 2023

(54) COMPOSITION SUITABLE FOR 3D PRINTING

(71) Applicant: PLANTICS HOLDING B.V., Arnhem (NL)

(72) Inventors: Beer HOLTHUIS, Arnhem (NL); Wridzer Jan Willem BAKKER, Arnhem (NL); Ferry Ludovicus THYS, St. Stevens Woluwe (BE)

(73) Assignee: PLANTICS HOLDING B.V., Arnhem (NL)

(21) Appl. No.: 17/756,335

(22) PCT Filed: Nov. 24, 2020
(86) PCT No.: PCT/EP2020/083250

§ 371 Date: May 23, 2022

(30) Foreign Application Priority Data
Nov. 25, 2019 (EP) 19211192.0

(51) Int. Cl. C08L 67/00

(52) U.S. Cl. CPC C08L 67/00; C08L 2201/06; C08L 2207/20; C08L 2201/08

(57) ABSTRACT

The invention pertains to a composition which is suitable for 3D printing, which composition comprises —a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, of at most 0.6, —solid filler, —diluent. The invention further pertains to a method for preparing a shaped object comprising the steps of —providing a composition as described herein, —extruding the composition through a printer nozzle to form a layer of the composition in a desired shape, building up the layers onto each other to form a shaped object, —subjecting the shaped object to a curing step to form a cured shaped object, wherein the curing step takes place during and/or after the extrusion step. The shaped object is also claimed.

The present invention is directed to a composition suitable for 3D-printing. The invention is also directed to use of the composition in 3D printing, and to the shaped objects thus obtained.

3D printing is an attractive method to obtain custom-made objects. It is finding wide application in many fields of use.

An issue with the current state of the art of 3D printed objects is that while it allows printing of thermoplastic polymers, processing of thermosetting polymers has been found quite difficult. There is need in the art for a composition which is can be processed through 3D printing to form a shaped object which is based on a thermosetting polymer and thus shows good heat stability. It is particularly attractive for such a composition to be based on biobased fossil-free components. The composition should make it possible to provide 3D shapes with good stability and an attractive visual appearance. It would be particularly attractive for the composition to be recyclable and/or biodegradable.

The present invention provides such a composition.

The present invention provides a composition which is suitable for 3D printing, which composition comprises
a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react of at most 0.6,
solid filler,
diluent.

The composition according to the invention can be processed using a 3D printer to form a shaped object, which can be subjected to a curing step, during or after printing. The polyester used in the present invention is a thermosetting material which results in good heat stability of the shaped object. By proper selection of the filler and the source of the polyester, a biobased, fossil-free, renewable, recyclable, and/or biodegradable composition can be obtained. Further advantages of the composition and its specific embodiments, and the further embodiments of the present invention will become evident from the further specification.

The present invention also provides a method for preparing a shaped object comprising the steps of
providing a composition as described herein
extruding the composition through a printer nozzle to form a layer of the composition in a desired shape, building up the layers onto each other to form a shaped object,
subjecting the shaped object to a curing step to form a cured shaped object, wherein the curing step takes place during and/or after the extrusion step.

The invention further provides a 3D printed object which comprises a polyester derived from an aliphatic polyol with 2-15 carbon atoms and an aliphatic polycarboxylic acid with 3 to 15 carbon atoms, the polyester having an extent of polymerization, which is the ratio of the fraction of functional groups that have reacted to the maximum of those functional groups that can react, of at least 0.5, in particular at least 0.6, and a filler.

The invention will be elucidated in more detail below.

The Polyester

The starting composition according to the invention comprises a polyester derived from an aliphatic polyol with 2-15 carbon atoms and an aliphatic polycarboxylic acid with 3 to 15 carbon atoms, the polymer having an extent of polymerization, which is the ratio of the fraction of functional groups that have reacted to the maximum of those functional groups that can react, in the range of 0.1-0.6.

The aliphatic polyalcohol used in the present invention comprises at least two hydroxyl groups, in particular at least three hydroxyl groups. In general, the number of hydroxyl groups will be 10 or less, more in particular 8 or less, or even 6 or less, in particular two or three. The polyalcohol has 2-15 carbon atoms. More in particular, the polyalcohol has 3-10 carbon atoms. It is preferred for the polyalcohol to contain no heteroatoms. More in particular the polyalcohol is an aliphatic polyalkanol containing only C, H, and O atoms. It is preferred for the polyalcohol to contain no non-carbon groups than hydroxyl groups. In a preferred embodiment of the present invention the polyalcohol contains a relatively large number of hydroxyl groups in comparison with its number of carbon atoms. For example, the ratio between the number of hydroxyl groups and the number of carbon atoms ranges from 1:4 (i.e. one hydroxyl group per four carbon atoms, or 8 carbon atoms for a dialcohol) to 1:1 (i.e. 1 hydroxyl groups per carbon atom). In particular, the ratio between the number of hydroxyl groups and the number of carbon atoms ranges from 1:3 to 1:1, more specifically, from 1:2 to 1:1. A group of specifically preferred polyalcohols is the group wherein the ratio ranges from 1:1.5 to 1:1.

Compounds wherein the ratio of hydroxyl groups to carbon atoms is 1:1 are considered especially preferred.

Examples of suitable polyalcohols include the trialcohols selected from glycerol, sorbitol, xylitol, and mannitol, and dialcohols selected from 1,2-propanediol, 1,3-propanediol, and 1,2-ethanediol. The use of compounds selected from the group of glycerol, sorbitol, xylitol, and mannitol is preferred, with the use of glycerol being particularly preferred.

The preference for glycerol is based on the following: In the first place glycerol has a melting point of 20° C., which allows easy processing, in particular as compared to xylitol, sorbitol, and mannitol, which all have melting points well above 90° C. Further, it has been found that glycerol gives a polymer of high quality, and thus combines the use of an easily accessible source material with good processing conditions and a high-quality product. Mixtures of different types of alcohol may also be used.

It is preferred, however, for the polyalcohol to consist for at least 50 mole % of glycerol, xylitol, sorbitol, or mannitol, in particular of glycerol, preferably at least 70 mole %, more in particular at least 90 mole %, or even at least 95 mole %. In one embodiment the polyalcohol consists essentially of glycerol.

The use of glycerol which is a side product of the manufacture of biodiesel by the transesterification reaction of glycerides with mono-alcohols is a specific embodiment of the present invention. Suitable monoalcohols include C1-C10 monoalcohols, in particular C1-C5 monoalcohols, more in particular C1-C3 monoalcohols, specifically methanol. The glycerides are mono-di- and esters of glycerol and fatty acids, the fatty acids generally having 10-18 carbon atoms. Suitable processes for manufacturing biodiesel with associated glycerol are known in the art.

The aliphatic polycarboxylic acid used in the present invention comprises at least two carboxylic acid groups, in particular at least three carboxylic acid groups. In general, the number of carboxylic acid groups will be 10 or less, more in particular 8 or less, or even 6 or less. The polycarboxylic acid has 3-15 carbon atoms. More in particular, the polycarboxylic acid has 3-10 carbon atoms. It is preferred for the polycarboxylic acid to contain no N or S heteroatoms. More in particular the polycarboxylic acid is an aliphatic polycarboxylic acid containing only C, H, and O atoms.

In one embodiment a dicarboxylic acid is used. The dicarboxylic acid, if used, may be any dicarboxylic acid which has two carboxylic acid groups and, in general, at most 15 carbon atoms. Examples of suitable dicarboxylic acids include itaconic acid, malic acid, succinic acid, glutaric acid, adipic acid and sebacic acid. Itaconic acid and succinic acid may be preferred.

In one embodiment a tricarboxylic acid is used. The tricarboxylic acid, if used, may be any tricarboxylic acid which has three carboxylic acid groups and, in general, at most 15 carbon atoms. Examples include citric acid, isocitric acid, aconitic acid (both cis and trans), and 3-carboxy-cis,cis-muconic acid. The use of citric acid is considered preferred, both for reasons of costs and of availability.

Where applicable the polycarboxylic acid may be provided as a whole or in part in the form of an anhydride, e.g., citric acid anhydride.

It has been found that the use of tricarboxylic acid results in a polyester with attractive properties. Therefore, in one embodiment, the polyacid comprises at least 10 wt. % of tricarboxylic acid, whether or not in combination with dicarboxylic acids, other tricarboxylic acids, and mixtures thereof. In one embodiment the polyacid comprises at least 30 wt. % of tricarboxylic acid, calculated on the total amount of polyacid, preferably at least 50 wt. %. In one embodiment the amount of tricarboxylic acid is at least 70 wt. %, more in particular at least 90 wt. %, or even at least 95 wt. %. In one embodiment the polyacid consists essentially of tricarboxylic acid, wherein the word essentially means that other acids may be present in amounts that do not affect the properties of the material.

In another embodiment of the invention the acid comprises at least 10 wt. % of dicarboxylic acid, calculated on the total amount of acid, preferably at least 30 wt. %, more preferably at least 50 wt. %. In one embodiment the amount of dicarboxylic acid is at least 70 wt. %.

In one embodiment the acid comprises a combination of at least 10 wt. % of tricarboxylic acid and at least 2 wt. % of dicarboxylic acid, more in particular at least 10 wt. % of tricarboxylic acid and at least 5 wt. % of dicarboxylic acid, or at least 10 wt. % of tricarboxylic acid and at least 10 wt. % of dicarboxylic acid. In this embodiment the weight ratio between the two types of acid may vary within wide ranges, depending on the properties of the desired material. In one embodiment, the dicarboxylic acid makes up between 2 and 90 wt. % of the total of dicarboxylic and tricarboxylic acid, in particular between 5 and 90 wt. %, more in particular between 10 and 90 wt. %, depending on the properties of the desired material. It is noted that the preferred ranges for the tricarboxylic acid specified above are also applicable to this embodiment. It has been found that the use of a tricarboxylic acid, in particular citric acid, results in the formation of a high-quality composite material, in particular in combination with the use of a trialcohol such as glycerol.

Not wishing to be bound by theory we believe that there are a number of reasons why the use of a tri-acid, in particular in combination with a tri-ol results in the formation of a high-quality composite material. In the first place, the use of a tri-acid, in particular in combination with a tri-ol, makes for a highly crosslinked polymer, resulting in increased strength.

The molar ratio between the polyalcohol and the polyacid will be governed by the ratio between the number of reacting groups in the alcohol(s) and acid(s) used. In general, the ratio between the number of OH groups and the number of acid groups is between 5:1 and 1:5. More in particular, the ratio may between 2:1 and 1:2, more specifically between 1.5:1 and 1:1.5, more preferably between 1.1:1 and 1:1.1. The theoretical molar ratio is 1:1.

Optionally a suitable catalyst can be used for the preparation of the polyester. Suitable catalysts for the manufacture of polyester are known in the art. Preferred catalysts are those that do not contain heavy metals. Useful catalysts are strong acids like, but not limited to, hydrochloric acid, hydroiodic acid and hydrobromic acid, sulfuric acid (H2SO4), nitric acid (HNO3), chloric acid (HClO3), boric acid, perchloric acid (HClO4) trifluoroacetic acid, p-toluenesulphonic acid, and trifluoromethanesulfonic acid. Catalysts like Zn-acetate and Mn-acetate can also be used, although they may be less preferred.

In one embodiment compounds are added to increase the interaction of the polymer with hydrophobic materials, or to increase the water resistance of the final product. Suitable compounds include for example, C5 to C22 saturated or unsaturated fatty acids or salts thereof, C5 to C22 saturated or unsaturated fatty alcohols, and dimeric and trimeric fatty acids or alcohols. For example, glycerol monostearate, triethyl citrate, and valeric acid can been used in this invention.

The compounds to increase hydrophobicity will generally be applied in an amount of 0.1-5 wt. %, calculated on the amount of the polymer, more in particular in an amount of 0.3-3 wt. %.

The polyester as it is present in the composition before 3D printing has an extent of polymerisation of at most 0.6. If the extent of polymerization is above 0.6, the processability of the polyester may decrease and, in some embodiments, an unacceptably large amount of water may be required to keep the viscosity of the composition sufficiently low for 3D printing. Evaporation of large amounts of water may be less attractive as it may result in shrinkage of the composition. It may be preferred for the extent of polymerization of the composition before 3D printing to be at most 0.5.

It may be preferred for the extent of polymerization of the polyester before 3D printing to be at least 0.1, in particular at least 0.2, more in particular at least 0.25, more in particular at least 0.3. A higher extent of polymerization before printing ensures that less curing after printing is required. This makes for a more efficient process. Further, a higher extent of polymerization may help to limit excessive interaction of the polymer with the filler.

The polymer is formed by combining the alcohol and the acid to form a liquid phase. Depending on the nature of the compounds this can be done, e.g., by heating a mixture of components to a temperature where the acid will dissolve in the alcohol, in particular in glycerol. Depending on the nature of the compounds this may be, e.g., at a temperature in the range of 20-250° C., e.g., 40-200° C., e.g. 60-200° C., or 90-200° C. In one embodiment, the mixture may be heated and mixed for a period of 5 minutes to 2 hours, more specifically 10 minutes to 45 minutes, at a temperature of 100-200° C., in particular 100-150°, more in particular at a temperature in the range of 100-140° C.

The composition before 3D printing generally comprises at least 5 wt. % of polyester. If less than 5 wt. % of polyester is present, the shaped object formed will not have the polyester content necessary to obtain the desired properties. It may be preferred for the composition to contain at least 10 wt. % polyester, in particular at least 20 wt. %. The composition generally comprises at most 85 wt. % of polyester. If more than 85 wt. % of polyester is present, there will be insufficient room for the further components of the composition. It may be preferred for the composition to contain at most 75 wt. % polyester, in particular at most 60 wt. % of polyester, in some embodiments at most 50 wt. % polyester.

The Filler

The composition comprises solid filler. the presence of filler is required to give shapeability to the composition as it is printed, and to prevent or limit foam formation. The solid filler may also give specific properties to the end product, such as a desirable look and feel, or a particular texture. The presence of a filler can also increase the strength of the product. By selecting the density of the filler it is possible to influence the density of the final product.

The composition before 3D printing generally comprises at least 10 wt. % of filler. If less than 10 wt. % of filler is present, forming a shaped object will be difficult. It may be preferred for the composition to contain at least 20 wt. % filler. The composition generally comprises at most 85 wt. % of filler. If more than 85 wt. % of filler is present, there will be insufficient room for the further components of the composition. It may be preferred for the composition to contain at most 80 wt. % of filler, in particular at most 70 wt. % of filler, in some embodiments at most 60 wt. % of filler or even at most 50 wt. % of filler.

The filler used in the composition according to the invention may be any solid material which is in a form that it can be processed through the nozzle of the envisaged 3D printer. It will be evident to the skilled person that the composition of the paste to be printed will have to be matched to the nozzle of the 3D printer, or vice versa. It is within the scope of the skilled person to perform such matching.

Generally, the filler will be a particulate material, but the use of yarn-type fibers is also possible in combination with a 3D printing process equipped for the processing of yarn-type fibers. Such printer nozzles are known in the art.

Where a particulate filler is used, it generally has a maximum particle size in the range of at most 50 mm, determined over its longest axis, depending on the type of material. In the context of the present specification the term particulate does not place any requirement on the shape of the material. the particulate material may be fibrous or non-fibrous. Where the particles are non-fibrous, the filler generally has a maximum particle size in the range of at most 10 mm, determined over its longest axis, depending on the type of material. It may be preferred to use a combination of larger particles and smaller particles.

In one embodiment, particles are used with an average particle size (determined over its longest axis) of at most 5 mm, in particular at most 2 mm. As a minimum value an average particle size of 0.001 mm may be mentioned.

In one embodiment, relatively small particles are used. In this case, the average particle size preferably is at most 0.5 mm. In some embodiments, the average particle size is at most 0.1 mm, or even at most 0.05 mm.

In another embodiment, larger particles are used. In this case, the average particle size is, for example, in the range of 0.5-5 mm, in particular 0.5-2 mm.

For objects with a relatively smooth surface finish it may be preferred for a part the filler to have a maximum particle size (Dv 90) of at most 1 mm, in particular at most 0.5 mm. For objects with a relatively rough surface finish, it may be preferred for the filler to contain a fraction of particles, e.g., between 5 and 50 vol. %, of particles with a particle size of at least 1 mm.

In one embodiment, the filler comprises a natural material such as a material derived from plants or animals.

Examples of plant-based materials include cellulose-based material such as fresh or used paper, fresh or used cardboard, wood or other plant material in any form, or combinations thereof. In one embodiment, a cellulose-based material is used derived from so-called virgin pulp which is obtained directly from the wood pulping process. This pulp can come from any plant material but mostly from wood. Wood pulp comes from softwood trees such as spruce, pine, fir, larch and hemlock, and hardwoods such as eucalyptus, popular, aspen and birch. In one embodiment, the cellulose-based material comprises cellulose material derived from recycled paper, such as cellulose pulp obtained from regenerated books, papers, newspapers and periodicals, egg cartons, and other recycled paper or cardboard products. A particular source is the use of reject paper fiber, which is paper fiber which is too short to be suitable for use in the manufacture of paper. Combinations of cellulose sources may also be used. Further examples of plant-derived material are cotton, flax, hemp, grass, reed, bamboo, coffee grounds, seed shells, e.g., from rice, burlap, kenaf, ramie, sisal, etc. and materials derived therefrom. In general plant material which has been comminuted to a suitable particle size, and where necessary dried to a suitable water content may be used. Examples of animal-derived materials include feathers, down, hair and derivatives thereof such as wool, but also bone meal.

The use of cellulose-based materials such as wood dust, wood pulp, and dust and pulp derived from other cellulose-based materials such as hemp has been found to give particularly attractive results.

Further examples of suitable fillers include fillers of ceramic materials, including oxides, e.g. alumina, beryllia, ceria, zirconia, silica, titania, and mixtures and combinations thereof, and non-oxides such as carbide, boride, nitride, silicide, and mixtures and combinations thereof such as silicium carbide. For the purposes of the present specification glass is considered a ceramic material. Glass may, e.g., be used in the form of short fibers, glass beads, whether solid or hollow, and ground glass particles. Suitable fillers further include materials like micaceaous fillers, calcium carbonate, and minerals such as phyllosilicates. Clay, sand, etc may also be used.

Suitable fillers also include polymer fillers, such as particles or short fibers of polyethylene, polypropylene, polystyrene, polyesters such as polyethylene terephthalate, polyvinylchloride, polyamide (e.g., nylon-6, nylon 6.6 etc.), polyacrylamide, and arylamide polymers such as aramid. Suitable fillers also include carbon fibers and carbon particulate materials. Comminuted cured polyester resin as used in the present invention may also be used as filler. Comminuted cured polyester resin containing a filler may also be used. This makes it possible to recycle used articles according to the invention to new articles.

In general, composites may also be used as filler, e.g., polymer particles provided with a filler.

Suitable further fillers encompass materials like starch which in lower concentrations can dissolve in the polyester composition. If materials of this type are used, they should be used in an amount sufficient to ensure that the material is also present in solid form.

Combinations of different types and materials of fillers may also be used.

The Diluent

The composition suitable for 3D printing according to the invention comprises a diluent. A diluent has been found to be necessary to ensure that the composition as it will be provide to the 3D printer has an adequate viscosity in all stages of its production process. Especially where a substantial amount of filler is to be incorporated into the polyester, a diluent is required to ensure a workable viscosity during mixing.

A suitable diluent needs to meet a number of requirements: it is a liquid with a low viscosity. It has no or low reactivity with the polyol and the carboxylic acid. It should be a good solvent for the polyol and the carboxylic acid. It should easily evaporate from the composition after 3D printing of the composition. The latter point is necessary to ensure that the printed product has sufficient stability to keep its shape, even before the printed object is subjected to a curing step.

While other liquids are possible, the use of water is considered preferred for technical, economical, and environmental reasons. Accordingly, the diluent generally consists for at least 50 wt. % of water, in particular at least 70 wt. %, more in particular at least 90 wt. %, even more in particular at least 95 wt. %.

The composition suitable for 3D printing generally comprises at least 5 wt. % of diluent. If less diluent is present, the effect as described above will not be obtained. It may be preferred for the amount of diluent to be at least 10 wt. %, in particular at least 15 wt. %, more in particular at least 20 wt. %. On the other hand, the amount of diluent should not be too high. It is generally at most 70 wt. %. At higher percentages, the stability of the object obtained after printing may be insufficient unless very high printing temperatures are used. It may be preferred to use at most 60 wt. % of diluent, in particular at most 50 wt. %.

Further Components

The composition may comprise further components such as stabilisers.

In one embodiment a stabilizer is used to improve the properties and processability of the composition before printing by increasing the interaction of the diluent, the filler, and the polyester, to help to provide a processable material without diluent separating from the other components.

In another embodiment, a stabilizer is added to improve the properties and processability of the composition during printing and after printing but before curing. In this case the stabilizer is added to ensure that the printed composition has a suitably high viscosity under printing conditions, and that the printed object has sufficient stiffness after printing but before curing. In general, these stabilisers increase the pseudoplasticity of the composition by bonding water, polyester, and filler, which allows to increase the “overhang”, which is the extent a cantilever can extend the base of the object. Suitable stabilisers include polymers such as starch, carboxymethylcellulose, polyethyleneglycol, hydroxy- or carboxypropylcellulose, hydroxy- or carboxyethylcellulose, and proteins. Suitable stabilisers further include inorganic salts such as calcium oxide, calcium hydroxide, and calcium carbonate. The inorganic salts have been found attractive if fast solidification of the composition is required. On the other hand, they may sometimes result in increased brittleness of the final product, also depending on the further composition thereof.

The amount of stabilizer to be added will depend on the effect to be achieved and on the further components in the composition. In general, stabiliser will be added in an amount of 0.1-30 wt. % calculated on the weight of the starting composition before printing. If too little stabiliser is used, no effect will be seen. If too much stabiliser is used, the viscosity of the composition may become unacceptably high while further beneficial effects are not obtained. An amount of 0.1-25 wt. %, in particular 0.5-20 wt. % more in particular 1-15 wt. % is generally preferred.

The composition can contain further components. Examples of further components which may be attractive to add include pigments, dyes, and comminuted recycled materials according to the invention, as discussed above. The addition of cured particles comprising a polyester derived from an aliphatic polyol with 2-15 carbon atoms and an aliphatic polycarboxylic acid with 3 to 15 carbon atoms, whether or not containing a filler, may also be considered.

In one embodiment, a composition suitable for 3D printing is provided which comprises 20-50 wt. % of polyester derived from glycerol and citric acid, with an extent of polymerization of 0.1-0.6, in particular 0.2 to 0.6. This can be combined with a filler, preferably in total amount of 10-80 wt. %. The filler can, e.g., be selected from cellulose-containing material such as wood pulp, wood dust, or paper fiber. The filler can e.g., be selected from glass spheres, in particular hollow glass spheres to obtain low-density materials, or cotton fibers. Combinations of the various types of filler may also be used. The use of particles of cured polyester derived from an aliphatic polyol with 2-15 carbon atoms and an aliphatic polycarboxylic acid with 3 to 15 carbon atoms, optionally comprising a filler, is also attractive. It is preferred for the composition to contain a stabilizer, in particular starch in an amount of, e.g., 0.5-25 wt. %, in particular 1-20 wt. %, or calcium hydroxide in an amount of, e.g., 0.5-20 wt. % or 1-15 wt. %, as these have been found to give good results.

Manufacture and Use of the Composition

The composition may be obtained by mixing the various components. In general it is preferred to first prepare the polymer, optionally in the presence of water by starting out from a solution of the monomers, and then adding the further components. The further components can be added in a single step or in multiple steps, at the same or different temperatures.

The invention also pertains to a process for preparing a shaped object comprising the steps of
providing a composition comprising polyester, filler, and diluent as described above,
extruding the composition through a printer nozzle to form a layer of the composition in a desired shape, building up the layers onto each other to form a shaped object,
and subjecting the shaped object to a curing step to form a cured shaped object, during and/or after the extrusion step.

This process is also indicated herein as 3D printing.

The extrusion step encompasses the step of extruding the composition through a printer nozzle. It is within the scope of the skilled person to adapt the viscosity of the composition to the printer nozzle in question, e.g., by adapting the temperature of the composition, or by selecting an appropriate amount of diluent, or, where present, stabilizer.

The minimum temperature is the melting point of the diluent, because it is necessary for the diluent to be in the liquid phase in the composition.

Extrusion at elevated temperature results in an appropriate viscosity of the composition. It is preferred for the extrusion step to be carried out at elevated temperature, e.g., at least 25° C., in particular at least 40° C., determined on the composition just before extrusion. It is preferred for the temperature to be below the boiling temperature of the diluent, as processing above the boiling point of the diluent may result in uncontrolled gas formation.

The temperature can be brought to the desired value by the provision of an air stream, in particular hot air, or using a microwave or infrared, or other suitable heating means which will be apparent to the skilled person.

Depending on the temperature during the extrusion step, curing of the polymer may take place during of just after extrusion. Nevertheless, in general it will be preferred to carry out a separate (additional) curing step.

If so desired, the shaped object may be subjected to a drying step before the curing step is carried out. The drying step, which is generally carried out at a temperature of room temperature, e.g., 15° C., or 20° C., to 100° C. is carried out to remove diluent from the shaped object. Drying at relatively low temperature, e.g., below 80° C., or below 50° C. may be preferred because of low energy consumption. Drying can be carried out, for example for 0.1 hours to 3 days, or 0.25 hours to 3 days, depending on the size and shape of the object, the amount of water present therein, and the amount of water in the shaped object. It is within the scope of a person skilled in the art to select suitable drying conditions. The application of vacuum to help to increase the evaporation of water may be considered.

The curing step is intended to further polymerise the polyester. The crux of the curing step is that the polyester is at reaction temperature, e.g., a product temperature of 80-250° C., in particular 100-200° C. Curing can be carried out in heating technology known in the art, e.g., in in an oven with an oven temperature from 80° C. up to 450° C. Different types of ovens may be used, including but not limited to belt ovens, convection ovens, microwave ovens, infra red ovens, hot-air ovens, conventional baking ovens and combinations thereof. Curing can be done in a single step, or in multiple steps. The curing times range from 5 seconds up to 24 hours, depending on the size and shape of the object and on the type of oven and temperature used. It is within the scope of a person skilled in the art to select suitable curing conditions. As longer curing times may be less attractive, it may be preferred for the curing time to be 5 seconds to 12 hours, in particular 5 seconds to 8 hours, more in particular 5 seconds to 4 hours, or 5 seconds to 2 hours. In particular for objects with a larger size, it may be preferred to apply a temperature gradient during curing, wherein the temperature at the start of the curing step is lower than the temperature at the end of the curing step. The application of a temperature gradient makes it possible to control the water removal rate from the object, which may help to prevent formation of surface inhomogeneities. In the case of larger objects, a preceding drying step as discussed above is considered preferred.

After curing the extent of polymerisation, determined gravimetrically, will generally be at least 0.5, in particular at least 0.6, more in particular at least 0.7, still more in particular at least 0.8, in some embodiments at least 0.9. The theoretical maximum extent of polymerization is 1.0.

After curing, the water content of the cured shaped object generally is below 10 wt. %, in particular below 5 wt. %, more in particular below 2 wt. %.

The invention also pertains to a 3D printed object which comprises a polyester derived from an aliphatic polyol with 2-15 carbon atoms and an aliphatic polycarboxylic acid with 3 to 15 carbon atoms, the polymer having an extent of polymerization, which is the ratio of the fraction of functional groups that have reacted to the maximum of those functional groups that can react, of at least 0.5, in particular at least 0.6, filler, and generally less than 10 wt. % of water.

The preferences indicated above for composition, water content, and degree of polymerization, the latter two of the cured object, also apply to this embodiment.

The cured object can be submitted to after-treatments known in the art, e.g., sanding, coating, or polishing, painting or other surface treatments.

The invention is suitable for providing objects for many applications, including decorative objects, furniture, etc. A particular use is in the production of large-scale prototypes. The use of 3D printing makes tailormade production possible in a manner which is less expensive than machining of a substrate, and less sensitive to deformation than 3D printed thermoplastic materials.

As will be evident to the skilled person, preferred embodiments of various aspects of the present invention can be combined, unless they are mutually exclusive.

The present invention will be elucidated by the following examples, without being limited thereto or thereby.

### EXAMPLE 1: PREPARATION OF SOLUTION OF POLYESTER POLYMER

1.0 kg of >99% pure glycerol and 2.0 kg of citric acid (purity >99%) were put in a stirred and heated reactor. Also 9 g of boric acid (0.5 m/m, >99% purity) was added. The mixture was heated up in about 15 minutes until 135° C. and kept at that temperature for 15 minutes followed by dilution with tap water to a water content of 60% and further cooling down. The resulting polymer has an extent of polymerisation of 0.4.

### EXAMPLE 2: MANUFACTURE OF SHAPED OBJECT WITH WOOD DUST AND STARCH

A composition suitable for 3D printing was prepared as follows. 10 Kilogram polyester polymer as described in Example 1 was heated to 90° C. and combined with 0.75 kg starch and 0.75 kg wood dust, followed by stirring. The mixture was cooled down to below 50° C. and a further 1.5 kg starch and 1.5 kg wood dust were added, followed by mixing.

The resulting composition consisted of 28 wt. % polyester, 15 wt. % starch, 15 wt. % wood dust, and 42 wt. % water. The extent of polymerisation of the polyester remained at 0.4.

The composition was used to print a shaped object using a 3D printer. The composition was provided to the 3D printer nozzle at a temperature of 50-60° C. and extruded through an 8 mm nozzle in a layer thickness of 3 mm at a rate of 20 mm/sec. Upon leaving the nozzle, the material is blasted with hot air (above 200° C.). The blasting with hot air is intended to stimulate the binding properties of the starch.

The shaped object was subsequently dried and cured in a hot air circulation oven at a temperature of 200° C. for 2 hours.

The water content of the cured object was below 5 wt. %. The object had an extent of polymerisation of above 0.8.

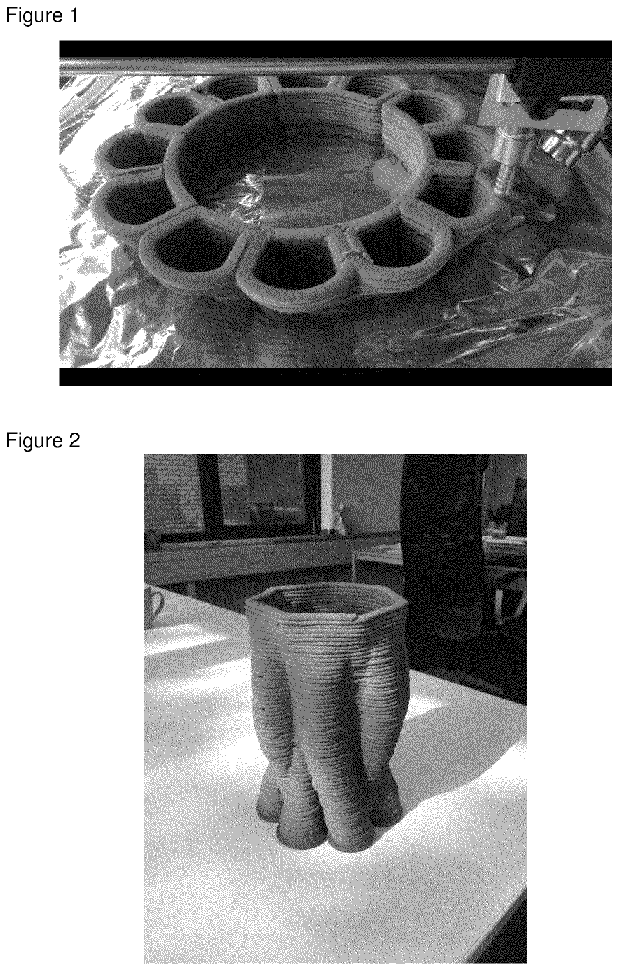

FIG. 1 shows the object during printing. As can be seen, the present invention allows the manufacture of complicated shapes in a controlled and reproducible manner and is stable enough to allow printing of objects with “overhang”, i.e. where the sides of the object extend beyond the side of the base.

### EXAMPLE 3: MANUFACTURE OF SHAPED OBJECT WITH WOOD DUST, STARCH, AND HOLLOW GLASS PEARLS

Grams of starch was mixed through 300 grams of the resin of Example 1 (containing 40 wt. % polymer and 60 wt. % water). The mixture was heated to 80° C., and stirred until the starch was dissolved. It was then cooled down to below 50° C. and a further 30 grams of starch was added. 40 grams of wood dust and 45 wt. % of hollow glass pearls were added, followed by mixing. The resulting composition consisted of 28 wt. % polyester, 10 wt. % starch, 10 wt. % wood dust, 10 wt. % hollow glass pearls, and 42 wt. % water.

The extent of polymerisation of the polyester was 0.4.

The mixture was 3D printed, dried, and cured as described in Example 2. The water content of the cured object was below 5 wt. %. The object had an extent of polymerisation of above 0.8.

The cured object is shown in FIG. 2. As can be seen, the present invention allows the manufacture of complicated shapes and is stable enough to allow printing of objects with “overhang”, i.e. where the sides of the object extend beyond the side of the base. The use of hollow glass pearls resulted in the formation of an object with a low density but still with the natural look and feels as can be obtained from the use of wood dust.

### EXAMPLE 4: MANUFACTURE OF SHAPED OBJECT WITH WOOD DUST AND CALCIUM HYDROXIDE

Grams of calcium hydroxide and 70 grams of wood dust were mixed. The mixture is added in portions to the 300 gram of the resin of example 1 (containing 40 wt. % polymer and 60 wt. % water), while ensuring that the temperature does not exceed 50° C. The resulting composition contained 30 wt. % resin, 7.5 wt. % calcium hydroxide, 17.5 wt. % wood dust, and 45 wt. % water. The extent of polymerisation of the polyester was 0.4.

The mixture was 3D printed, dried, and cured as described in Example 2. The water content of the cured object was below 5 wt. %. The object had an extent of polymerisation of above 0.8.

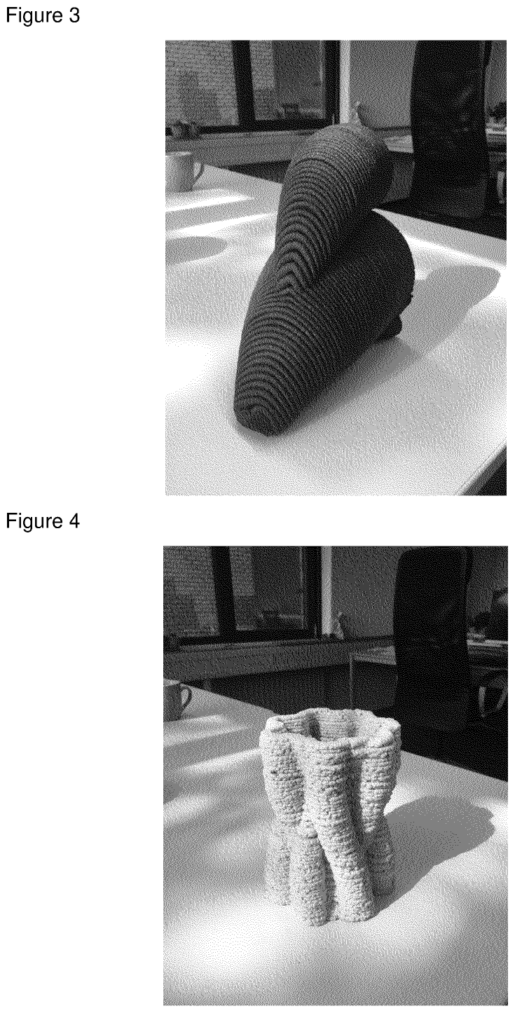

The cured object is shown in FIG. 3. As can be seen from the figure, this composition allows for the printing of complex 3D shapes with high accuracy.

### EXAMPLE 5: MANUFACTURE OF SHAPED OBJECT WITH STARCH AND COTTON FIBRE

Grams of starch was mixed through 300 grams of the resin of Example 1 (containing 40 wt. % polymer and 60 wt. % water). The mixture was heated to 80° C., and stirred until the starch was dissolved. It was then cooled down to below 50° C. and a further 30 grams of starch was added. 75 grams of cotton fibre and 10 grams of aerosil (fumed silica) as thickener were added, followed by mixing. The resulting composition consisted of 28 wt. % polyester, 10 wt. % starch, 17 wt. % cotton fibre, 2 wt. % aerosol, and 42 wt. % water.

The extent of polymerisation of the polyester was 0.4.

The mixture was 3D printed, dried, and cured as described in Example 2. The water content of the cured object was below 5 wt. %. The object had an extent of polymerisation of above 0.8.

The cured object is shown in FIG. 4. As can be seen from the figure, this composition, which contains longer fibers, results in an object with a rough surface. allows for the printing of complicated 3D shapes.

### EXAMPLE 6: MANUFACTURE OF SHAPED OBJECT WITH CMC AND REJECT PAPER FIBER

300 Grams of the resin of Example 1 was heated to 80° C. 75 Grams of reject paper fibers and 9 grams carboxymethylcellulose stabiliser were added, followed by mixing. The resulting composition consisted of 31 wt. % polyester, 2 wt. % CMC, 20 wt. % reject paper fiber, and 47 wt. % water. The extent of polymerisation of the polyester was 0.4.

The mixture was 3D printed, dried, and cured as described in Example 2. The water content of the cured object was below 5 wt. %. The object had an extent of polymerisation of above 0.8.

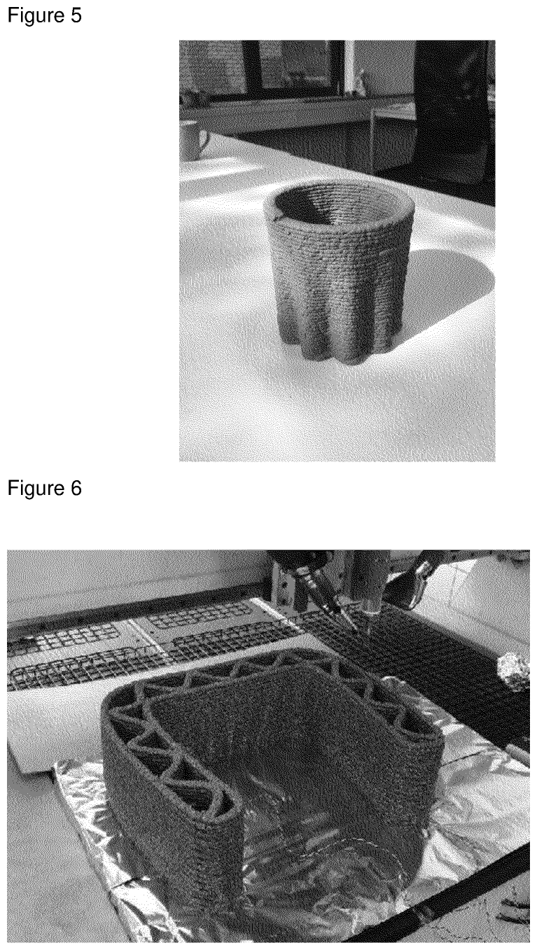

The cured object is shown in FIG. 5. As can be seen from the figure, the present invention makes it possible to convert reject paper fiber into a product with an attractive 3D shape. Reject paper fiber is a waste stream from the paper recycle industry. It contains the fibers which are too short for recycling into new paper. In addition to fibers, the fraction also contains calcium carbonate 10-30 wt. % calcium carbonate.

### EXAMPLE 7: MANUFACTURE OF LARGE-SCALE OBJECT BASED ON HEMP PARTICLES

In a 25 liter planetary mixer 5 kg water was heated to a temperature of 100° C. 0.75 kg starch was mixed with 1 kg hemp particles and the mixture was added to the water. The hemp particles were a mixture of hemp shives and fibrous material and contained material of different particle sizes, the largest particles being of the order of 5 mm. Then, 5 kg of resin prepared in accordance with example 1 was added. The mixture was stirred and allowed to cool to room temperature. 0.35 kg of hemp particles were mixed with 1 kg calcium hydroxide. Half of this mixture was added to the resin composition, the mixture was stirred for one hour, and the other half of the mixture of hemp and calcium hydroxide was added, again followed by stirring. The resulting composition consisted of 31 wt. % polyester, 10 wt. % hemp particles, 8 wt. % CaOH, 6 wt. % of starch, and the balance water. The extent of polymerisation of the polyester was 0.4.

The composition was used to print a shaped object using a 3D printer. The composition was provided to the 3D printer nozzle at a temperature of 70° C. and extruded through an 11 mm nozzle in a layer thickness of 5 mm at a rate of 20 mm/sec. Upon leaving the nozzle, the material is blasted with hot air (above 200° C.). The blasting with hot air is intended to stimulate the evaporation of water resulting in an increased stability of the object.

The shaped object was subsequently dried and cured in a hot air circulation oven at a temperature of 160° C. for 2 hours.

The water content of the cured object was below 5 wt. %. The object had an extent of polymerisation of above 0.8.

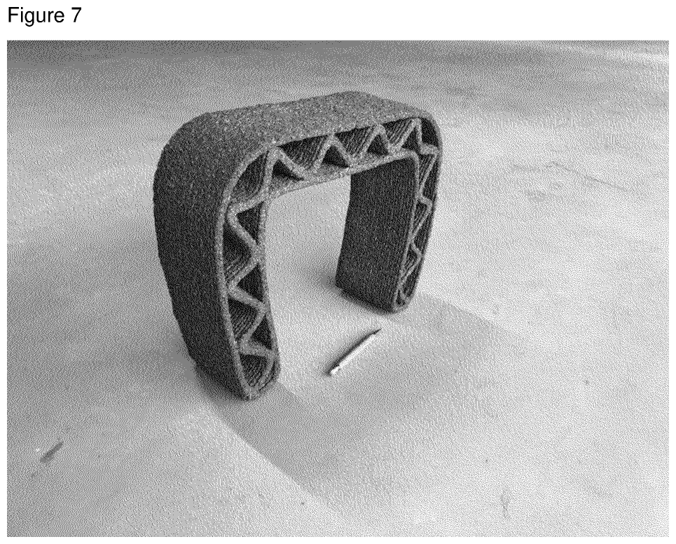

A picture of the object just after 3D printing is in FIG. 6. A picture of the cured object is in FIG. 7 (pen for scale). As can be seen from the pictures, the object is stable and self-supporting. The object had the following dimensions: a height of 35 cm, a width of 43 cm, and a thickness of 13 cm.

1. A composition which is suitable for 3D printing, which composition comprises
a polyester derived from an aliphatic polyol with 2-15 carbon atoms and an aliphatic polycarboxylic acid with 3 to 15 carbon atoms, the polyester having an extent of polymerization, which is a ratio of a fraction of functional groups that have reacted to a maximum of those functional groups that can react, of at most 0.6,
a solid filler, and
a diluent.

2. The composition according to claim 1, wherein the extent of polymerization of the polyester before 3D printing is at least 0.1.

3. The composition according to claim 1, wherein the composition contains 0.1-30 wt. % of a stabilizer.

4. The composition according to claim 3, wherein the stabilizer is selected from the group consisting of polymers, proteins and inorganic salts.

5. The composition according to claim 1, wherein the polycarboxylic acid comprises at least 10 wt. % of tricarboxylic acid calculated based on a total amount of the polycarboxylic acid.

6. The composition according to claim 1, wherein the polyol comprises at least 50 mole % of a compound selected from the group consisting of glycerol, xylitol, sorbitol, and mannitol.

7. The composition according to claim 1, which contains 20-50 wt. % of the polyester, based on a total weight of the composition.

8. The composition according to claim 1, which contains 10-85 wt. % of the solid filler, based on a total weight of the composition.

9. The composition according to claim 1, wherein the solid filler is selected from the group consisting of one or more of cellulose-containing material, glass spheres and particles of cured polyester derived from an aliphatic polyol with 2-15 carbon atoms and an aliphatic polycarboxylic acid with 3 to 15 carbon atoms.

10. The composition according to claim 1, wherein the composition contains 20-70 wt. % of a diluent, based on a total weight of the composition.

11. A method for preparing a shaped object comprising steps of
providing a composition according to claim 1,
extruding the composition through a printer nozzle to form a layer of the composition in a desired shape,
repeating the extruding step on or more times and building up the formed layers onto each other to form a shaped object, and
subjecting the shaped object to a curing step to form a cured shaped object, wherein the curing step takes place during and/or after the extrusion step.

12. The method according to claim 11, wherein a separate curing step is carried out after the extrusion step.

13. The method according to claim 11, wherein curing is carried out at a temperature of 80-250° C.

14. The method according to claim 11, wherein the cured shaped object has an extent of polymerization, determined gravimetrically, of at least 0.5 and/or a water content of below 10 wt.

15. A 3D printed object which comprises
a polyester derived from an aliphatic polyol with 2-15 carbon atoms and an aliphatic polycarboxylic acid with 3 to 15 carbon atoms, the polyester having an extent of polymerization, which is a ratio of a fraction of functional groups that have reacted to a maximum of those functional groups that can react, of at least 0.5,
a filler, and
less than 10 wt. % of water, based on a total weight of the 3D printed object.

16. The composition according to claim 1 wherein the extent of polymerization is at least 0.3.

17. The composition according to claim 4, wherein the polymer is selected from the group consisting of starch, carboxymethylcellulose, polyethyleneglycol, hydroxy- or carboxypropylcellulose, and hydroxy- or carboxyethylcellulose, and the inorganic salt is selected from the group consisting of calcium oxide, calcium hydroxide, and calcium carbonate.

18. The composition according to claim 5, which comprises at least 70 wt. % of the tricarboxylic acid.

19. The composition according to claim 18, wherein the tricarboxylic acid is citric acid.

20. The composition according to claim 6, wherein the polyol comprises at least 70 mole % of glycerol.
